(19) United States
(12) Patent Application Publication
(10) Pub. No.: US 2022/0398905 A1
(43) Pub. Date: Dec. 15, 2022

(54) APPLICATION-BASED HARDWARE CAMERA AND MICROPHONE INDICATORS

(71) Applicant: HEWLETT-PACKARD DEVELOPMENT COMPANY, L.P., Spring, TX (US)

(72) Inventors: Guoxing YANG, Spring, TX (US); Chan Woo PARK, Spring, TX (US); Richard S. LIN, Spring, TX (US)

(21) Appl. No.: 17/343,353

(22) Filed: Jun. 9, 2021

(51) Int. Cl. G08B 5/36; G06F 3/147

(52) U.S. Cl. CPC G08B 5/36; G06F 3/147

(57) ABSTRACT

In some examples, an electronic device comprises a display device having a first hardware indicator and a second hardware indicator, a camera, a microphone, and a processor coupled to the microphone, the camera, and the first and the second hardware indicators. The processor is to, based on a type of an application in use, control the first hardware indicator in response to a state of the camera, wherein the application has access to the camera and the microphone; and based on the type of the application in use, control the second hardware indicator in response to a state of the microphone.

### BACKGROUND

Electronic devices such as desktops, laptops, notebooks, tablets, and smartphones include recording devices such as cameras and microphones. An electronic device may also include indicators that indicate whether a recording device is in use. Such indicators may be hardware indicators (e.g., a light-emitting diode (LED)) or software indicators (e.g., icons that are generated by machine-readable instructions and are graphical representations displayed in an application window of a display device). The hardware and software indicators indicate to a user that an application (e.g., machine-readable instructions that enable a user to perform tasks) is utilizing the recording devices.

### BRIEF DESCRIPTION OF THE DRAWINGS

Various examples are described below referring to the following figures:

FIG. 1 is a schematic diagram of an electronic device having hardware indicators for recording devices, in accordance with various examples.

FIG. 2 is a schematic diagram of an electronic device having hardware indicators for recording devices, in accordance with various examples.

FIG. 3 is a schematic diagram of an electronic device having hardware indicators for recording devices, in accordance with various examples.

FIG. 4 is a schematic diagram of an electronic device for controlling hardware indicators for recording devices, in accordance with various examples.

FIGS. 5A and 5B are examples of states of application-based hardware indicators for recording devices of an electronic device, in accordance with various examples.

### DETAILED DESCRIPTION

As described above, electronic devices such as desktops, laptops, notebooks, tablets, and smartphones include recording devices such as cameras and microphones. An electronic device may also include indicators that indicate whether a recording device is in use. For instance, the electronic device that includes a camera may also include a camera light (e.g., an LED positioned on the bezel of a display device). When the camera is in use, the light turns on, and when the camera is not in use, the light turns off. However, the camera light may not be able to have an icon that indicates the camera light is for the camera. The electronic device that includes a microphone may also include a microphone icon. When the microphone is unmuted, the icon may display an image representing the microphone, and when the microphone is muted, the icon may have a “\” or “x” across the image. However, the electronic device may not have be able to have a hardware indicator that indicates the microphone is muted.

The camera light and the microphone icon described above may be system-level indicators, meaning that they indicate a status of the camera and a status of the microphone irrespective of any particular application in use. However, individual applications (e.g., videoconferencing applications, video recording applications, audio recording applications) also may include indicators to indicate the state of the camera or the state of the microphone. Each application may present such indicators in different locations, and the indicators' appearances, locations, or a combination of both may depend on a role being played by a user of the application. For instance, in a videoconferencing application, the user's role (e.g., presenter vs. attender) may determine the appearance and location of the indicators. Having various camera indicators and microphone indicators in various locations may be confusing and diminish a user experience.

This description describes an electronic device that includes a hardware indicator to indicate when a camera (e.g., hardware camera indicator) is in use and a hardware indicator to indicate when a microphone (e.g., hardware microphone indicator) is in use. The hardware indicators may also indicate a type of an application that is utilizing the camera and the microphone. The type of the application describes the application based on a task performed by the application. For example, the types of applications may include conferencing and non-conferencing. In response to an application having a conferencing type, the hardware camera indicator may be a first color, and in response to an application having a non-conferencing type, the hardware camera indicator may be a second color. By providing such hardware indicators for the camera and microphone, the user experience is improved because, regardless of which application is in use and without looking in multiple locations, the user is able to quickly discern whether the camera is on or off, whether the microphone is muted or unmuted, and what type of application is in use. In some examples, the hardware indicators include sensors that enable a user to enable or disable the camera (e.g., switch the state of the camera between on and off) or the microphone (e.g., switch the state of the microphone between mute and unmute), respectively. By including sensors with the indicators, the user experience is improved because, regardless of which application is in use, the user is able to quickly disable or enable the camera or mute or unmute the microphone.

In one example in accordance with the present description, an electronic device is provided. The electronic device comprises a display device having a first hardware indicator and a second hardware indicator, a camera, a microphone, and a processor coupled to the microphone, the camera, and the first and the second hardware indicators. The processor is to, based on a type of an application in use, control the first hardware indicator in response to a state of the camera and, based on the type of the application in use, control the second hardware indicator in response to a state of the microphone, where the application has access to the camera and the microphone.

In another example in accordance with the present description, an electronic device is provided. The electronic device comprises a camera, a microphone, a display bezel having a first hardware indicator to indicate a state of the camera and a second hardware indicator to indicate a state of the microphone, and a processor coupled to the camera, the microphone, and the first and second hardware indicators. The processor is to execute a first application or a second application; based on an execution of the first application, control the first hardware indicator to display a first color and the second hardware indicator to display a second color; and based on an execution of the second application, control the first hardware indicator to display a third color and the second hardware indicator to display a fourth color.

In another example in accordance with the present description, a non-transitory machine-readable medium storing machine-readable instructions is provided. The non-transitory machine-readable medium is to store machine-readable instructions which, when executed by a processor of an electronic device, cause the processor to determine a state of a camera based on a type of an application in use; based on the state of the camera, control a color of a first hardware indicator housed within a chassis; determine a state of a microphone based on the type of the application in use; and based on the state of the microphone, control a color of a second hardware indicator housed within the chassis.

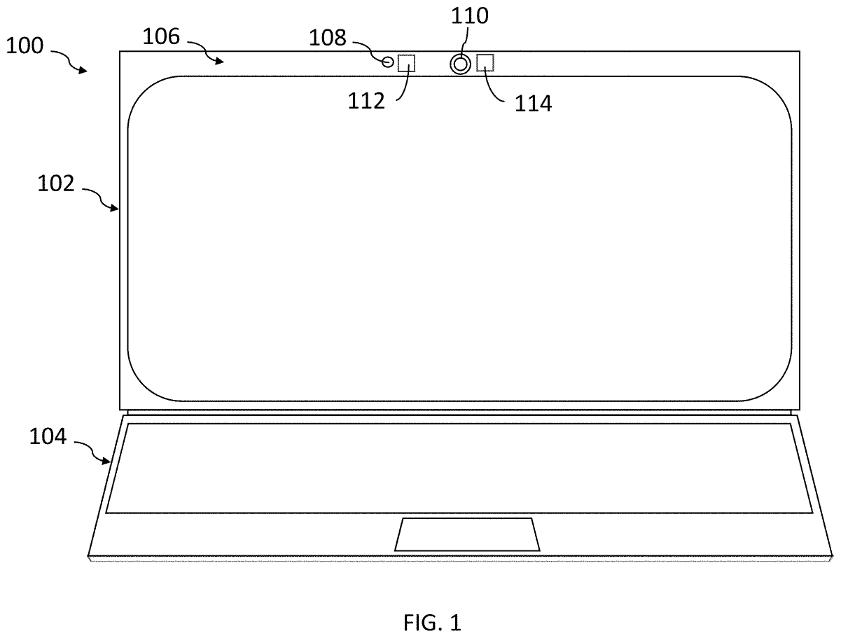

Referring now to FIG. 1, a schematic diagram of an electronic device 100 having hardware indicators 112, 114 for recording devices 108, 110 is depicted in accordance with various examples. The electronic device 100 comprises a display device 102 having a bezel 106, a chassis 104, recording devices 108, 110, and hardware indicators 112, 114. The electronic device 100 may be a desktop, a laptop, a notebook, a tablet, a smartphone, or other electronic computing device having recording devices. The display device 102 may be to display data generated by the electronic device 100. The chassis 104 may house internal hardware components of the electronic device 100 (e.g., storage devices, processors, communication buses, power supplies, fans). The bezel 106 may secure a display panel of the display device 102 within a chassis of the display device 102. The bezel 106 may be plastic, glass, glass coated with a conductive material, or some other suitable material for securing a display panel of the display device 102 within a chassis. The bezel 106 comprises the recording devices 108, 110 and the hardware indicators 112, 114. The recording devices 108, 110 may be a microphone 108 and a camera 110. The hardware indicators 112, 114 may be a hardware microphone indicator 112 and a hardware camera indicator 114. The hardware indicators 112, 114 may comprise lights, display panels, and sensors. The lights may be LEDs or other suitable low-energy, compact lights. The display panels of the hardware indicators 112, 114 may comprise transparent images that represent the recording devices 108, 110. For example, the hardware microphone indicator 112 comprises an image of a microphone and the hardware camera indicator 114 comprises an image of a camera. The sensors may be a touch sensor, a mechanical button, or any suitable touch-responsive device for detecting a user interaction.

In various examples, as described above, the hardware microphone indicator 112 indicates the state of the microphone 108 and the hardware camera indicator 114 indicates the state of the camera 110. Responsive to an on state (e.g., in use by an application, unmuted) of the microphone 108, the electronic device 100 switches on the hardware microphone indicator 112. Responsive to an off state (e.g., not in use by an application, muted) of the microphone 108, the electronic device 100 switches off the hardware microphone indicator 112. Responsive to an on state (e.g., in use by an application) of the camera 110, the electronic device 100 switches on the hardware camera indicator 114. Responsive to an off state (e.g., not in use by an application) of the camera 110, the electronic device 100 switches off the hardware camera indicator 114. By providing the hardware microphone indicator 112 and the hardware camera indicator 114 on the bezel 106 of the display device 102, the user experience is improved because, without looking in multiple locations, the user is able to quickly discern whether the camera 110 is on or off and whether the microphone 108 is muted or unmuted.

In various examples, the electronic device 100 switching on the hardware microphone indicator 112 or the hardware camera indicator 114 switches on the light of the hardware microphone indicator 112 or the hardware camera indicator 114, respectively. The electronic device 100 switching off the hardware microphone indicator 112 or the hardware camera indicator 114 switches off the light of the hardware microphone indicator 112 or the hardware camera indicator 114, respectively. In some examples, responsive to the on state of the microphone 108 and the on state of the camera 110, the electronic device 100 switches a color of a light of the hardware microphone indicator 112 and a color of a light of the hardware camera indicator 114 to a first color. For example, responsive to on states of the microphone 108 and the camera 110, the electronic device 100 switches the color of the lights of the hardware microphone indicator 112 and the hardware camera indicator 114 to green. In other examples, responsive to the on states of the microphone 108 and the camera 110, the electronic device 100 switches the color of the light of the hardware microphone indicator 112 and the color of the light of the hardware camera indicator 114 to different colors. For example, responsive to the on state of the microphone 108, the electronic device 100 switches the color of the hardware microphone indicator 112 to blue, and responsive to the on state of the camera 110, the electronic device 100 switches the color of the hardware camera indicator 114 to green. Having different color lights for the hardware microphone indicator 112 and the hardware camera indicator 114 may reduce user confusion by identifying the microphone 108 and the camera 110 with distinct colors.

In some examples, the electronic device 100 switching on the hardware microphone indicator 112 or the hardware camera indicator 114 causes the display panel of the hardware microphone indicator 112 or the hardware camera indicator 114 to display the image of the microphone or the image of the camera, respectively. In some examples, the electronic device 100 switching off the hardware microphone indicator 112 or the hardware camera indicator 114 causes the display panel of the hardware microphone indicator 112 or the hardware camera indicator 114 to display the image of the microphone or the image of the camera, respectively, having a mark indicating that the microphone 108 or the camera 110, respectively, is off. The mark may be a “\,” an “x,” or other suitable mark representing unavailable or off. In various examples, the electronic device 100 switching off the hardware microphone indicator 112 or the hardware camera indicator 114 causes the display panel of the hardware microphone indicator 112 or the hardware camera indicator 114 to display no image of the microphone or no image of the camera, respectively, to indicate that the microphone 108 or the camera 110, respectively, is off. By providing hardware indicators 112, 114 having images for the camera 110 and the microphone 108 on the bezel 106 of the display device 102, the user experience is improved because, without looking in multiple locations, the user is able to quickly discern whether the camera 110 is on or off and whether the microphone 108 is muted or unmuted.

In various examples, responsive to the on state of the microphone 108, the electronic device 100 may control the hardware microphone indicator 112 to display a first color. Responsive to the off state of the microphone 108, the electronic device 100 may control the hardware microphone indicator 112 to display a second color. For example, the electronic device 100 switches on a green light of the hardware microphone indicator 112 to indicate the on state and switches on a red light of the hardware microphone indicator 112 to indicate the off state. Responsive to the on state of the camera 110, the electronic device 100 may control the hardware camera indicator 114 to display a first color. Responsive to the off state of the camera 110, the electronic device 100 may control the hardware camera indicator 114 to display a second color. For example, the electronic device 100 switches on a blue light of the hardware camera indicator 114 to indicate the on state and switches on a red light of the hardware camera indicator 114 to indicate the off state.

As described above, in some examples, the hardware indicators 112, 114 include sensors that enable a user to enable or disable the camera 110 (e.g., switch a state of the camera 110 between on and off) or the microphone 108 (e.g., switch a state of the microphone 108 between mute and unmute), respectively. Responsive to the electronic device 100 detecting a user interaction with a sensor of the hardware microphone indicator 112, the electronic device 100 switches a state of the hardware microphone indicator 112 and the microphone 108 from a first state to a second state. For example, responsive to the hardware microphone indicator 112 indicating the on state of the microphone 108 when the electronic device 100 detects the user interaction, the electronic device 100 switches the hardware microphone indicator 112 to the off state and mutes the microphone 108. Responsive to the electronic device 100 detecting a user interaction with a sensor of the hardware camera indicator 114, the electronic device 100 switches a state of the hardware camera indicator 114 and the camera 110 from a first state to a second state. For example, responsive to the hardware camera indicator 114 indicating the off state of the camera 110 when the electronic device 100 detects the user interaction, the electronic device 100 switches the hardware camera indicator 114 to the on state and switches on the camera 110. By providing hardware indicators 112, 114 having sensors on the bezel 106 of the display device 102, the user experience is improved because, without looking in multiple locations, the user is able to quickly control whether the camera 110 is on or off and whether the microphone 108 is muted or unmuted.

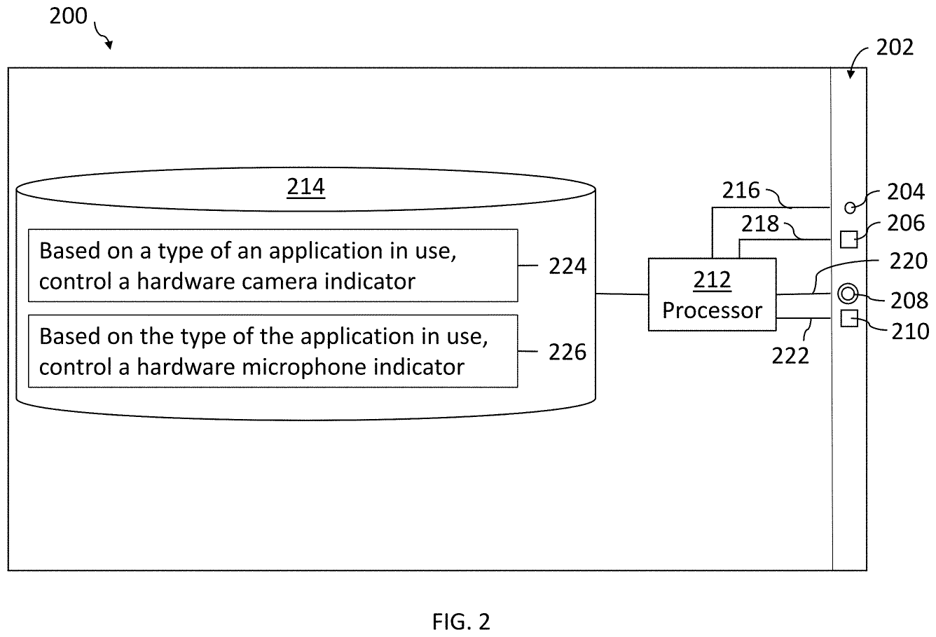

Referring now to FIG. 2, a schematic diagram of an electronic device 200 having hardware indicators 206, 210 for recording devices 204, 208 is depicted, in accordance with various examples. The electronic device 200 may be the electronic device 100. The hardware indicators 206, 210 may be the hardware indicators 112, 114. The recording devices 204, 208 may be the recording devices 108, 110. The electronic device 200 comprises a display bezel 202, the recording devices 204, 208, the hardware indicators 206, 210, a processor 212, a storage device 214, and communication buses 216, 218, 220, 222. The display bezel 202 may secure a display panel of the electronic device 200. The display bezel 202 comprises the recording devices 204, 208 and the hardware indicators 206, 210. The recording devices 204, 208 may be a microphone 204 and a camera 208. The hardware indicators 206, 210 may be a hardware microphone indicator 206 and a hardware camera indicator 210. The processor 212 may be a microprocessor, a microcomputer, a microcontroller, a programmable integrated circuit, a programmable gate array, or other suitable device for controlling operations of the electronic device 200. The storage device 214 may be a hard drive, a solid-state drive (SSD), flash memory, random access memory (RAM), or other suitable memory device. The communication buses 216, 218, 220, 222 enable data transfers between components coupled to the communication buses 216, 218, 220, 222.

In some examples, the processor 212 couples to the storage device 214, the microphone 204 via the communication bus 216, the hardware microphone indicator 206 via the communication bus 218, the camera 208 via the communication bus 220, and the hardware camera indicator 210 via the communication bus 222. The storage device 214 may store machine-readable instructions that, when executed by the processor 212, may cause the processor 212 to perform some or all of the actions attributed herein to the processor 212. The machine-readable instructions may be the machine-readable instructions 224, 226.

In various examples, when executed by the processor 212, the machine-readable instructions 224, 226 cause the processor 212 to control the hardware microphone indicator 206 and the hardware camera indicator 210. The machine-readable instruction 224 causes the processor 212 to, based on a type of an application in use, control the hardware camera indicator 210. As described above, the type of the application describes the task performed by the application and may include conferencing and non-conferencing. The application in use has access to the microphone 204 and the camera 208. The machine-readable instruction 226 causes the processor 212 to, based on the type of the application in use, control the hardware microphone indicator 206. For example, responsive to an application having the conferencing type and the application indicating on states of the microphone 204 and the camera 208, the processor 212 controls the hardware microphone indicator 206 and the hardware camera indicator 210 to display a green color. Responsive to the application having the conferencing type and the application indicating the on state of the microphone 204 and the off state of the camera 208, the processor 212 controls the hardware microphone indicator 206 to display a green color and controls the hardware camera indicator 210 to display a red color. By providing hardware indicators 206, 210 for the camera 208 and the microphone 204, respectively, the user experience is improved because, regardless of which application is in use and without looking in multiple locations, the user is able to quickly discern whether the camera 208 is on or off, whether the microphone 204 is muted or unmuted, and what type of application is in use.

In various examples, responsive to the application having the non-conferencing type and the application indicating on states of the microphone 204 and the camera 208, the processor 212 controls the hardware microphone indicator 206 and the hardware camera indicator 210 to display the images of the microphone and the camera, respectively. For example, the processor 212 switches on a green light of the hardware microphone indicator 206 and the hardware camera indicator 210 to illuminate the images.

In some examples, in response to an application having a first type and the microphone 204 and the camera 208 having the same states (e.g., both on or off), the processor 212 switches the hardware camera indicator 210 and the hardware microphone indicator 206 to a first color. In response to the application having a second type and the microphone 204 and the camera 208 having the same states, the processor 212 switches the hardware camera indicator 210 and the hardware microphone indicator 206 to a second color. For example, responsive to an application having the conferencing type and the microphone 204 and the camera 208 having on states, the processor 212 switches the hardware camera indicator 210 and the hardware microphone indicator 206 to a green color. Responsive to an application having the non-conferencing type and the microphone 204 and the camera 208 having on states, the processor 212 switches the hardware camera indicator 210 and the hardware microphone indicator 206 to a yellow color.

In various examples, the type of the application may include additional types. For example, the type of the application may be conferenced, secured, or non-secured. The processor 212 may control a color of the hardware indicators 206, 210 based on the type of the application in use and the states of the recording devices 204, 208. For example, in response to an application having the conferencing type and the microphone 204 and the camera 208 having on states, the processor 212 switches the hardware camera indicator 210 and the hardware microphone indicator 206 to a first color. In response to an application having the secured type and the microphone 204 and the camera 208 having on states, the processor 212 switches the hardware camera indicator 210 and the hardware microphone indicator 206 to a second color. In response to the application having the non-secured type and the microphone 204 and the camera 208 having on states, the processor 212 switches the hardware camera indicator 210 and the hardware microphone indicator 206 to a third color. For example, the processor 212 switches the hardware camera indicator 210 and the hardware microphone indicator 206 to green to indicate on states for the camera 208 and the microphone 204 in a conferencing application. In a secured application, the processor 212 switches the hardware camera indicator 210 and the hardware microphone indicator 206 to yellow to indicate on states for the camera 208 and the microphone 204. The processor 212 switches the hardware camera indicator 210 and the hardware microphone indicator 206 to red to indicate on states for the camera 208 and the microphone 204 in a non-secured application.

In some examples, sensors of the hardware indicators 206, 210 may respond in a subset of the types of the applications. For example, responsive to an application having the secured type, the processor 212 may disable the sensors of the hardware indicators 206, 210. Responsive to the electronic device 200 switching to an application having the non-secured type, the processor 212 may respond to a user interaction with the sensors of the hardware indicators 206, 210. For example, responsive to the electronic device 200 detecting a non-secured type of the application in use and a user interaction with a sensor of the hardware microphone indicator 206, the electronic device 200 switches a state of the hardware microphone indicator 206 and the microphone 204 to indicate the state of the microphone 204 in the application. In other examples, the sensor of the hardware microphone indicator 206 may respond in a subset of the types of the applications and the sensor of the hardware camera indicator 210 may respond in the multiple types of the applications. For example, responsive to an application having the non-conference type, the processor 212 may disable the sensor of the hardware microphone indicator 206 and respond to a user interaction with the sensor of the hardware camera indicator 210. Responsive to the electronic device 200 switching to an application having the conference type, the processor 212 may enable the sensor of the hardware microphone indicator 206 and respond to a user interaction with the sensor of the hardware microphone indicator 206. By including application-based sensors with the hardware indicators 206, 210, the user experience is improved because, the user is able to quickly disable or enable the camera 208 or mute or unmute the microphone 204 based on the application in use.

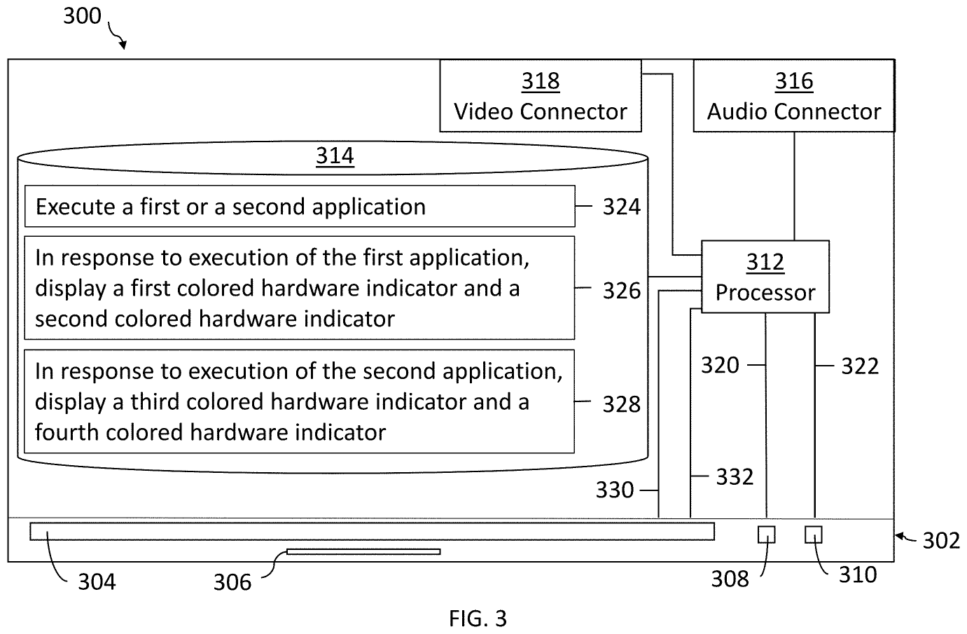

Referring now to FIG. 3, a schematic diagram of an electronic device 300 having hardware indicators 308, 310 for recording devices (not explicitly shown) is depicted, in accordance with various examples. The electronic device 300 may be the electronic device 100, 200. The hardware indicators 308, 310 may be the hardware indicators 112, 114 or the hardware indicators 206, 210. The electronic device 300 comprises a chassis 302, input devices 304, 306, the hardware indicators 308, 310, a processor 312, a storage device 314, an audio connector 316, a video connector 318, and communication buses 320, 322, 330, 332. An outer surface of the chassis 302 houses the input devices 304, 306 and the hardware indicators 308, 310. The hardware indicators 308, 310 may be a hardware microphone indicator 308 and a hardware camera indicator 310. The hardware microphone indicator 308 may indicate a state of a microphone coupled to the audio connector 316. The audio connector 316 may be an audio jack, a universal serial bus (USB) connector, a Wi-Fi® connector, a Bluetooth® connector, or any other suitable connector for an audio device. The hardware camera indicator 310 may indicate a state of a camera coupled to the video connector 318. The video connector 318 may be a USB connector, a Wi-Fi® connector, a Bluetooth® connector, or any other suitable connector for a video device. The processor 312 may be the processor 212. The storage device 314 may be the storage device 214. The communication buses 320, 322 enable data transfers between components coupled by the communication buses 320, 322, 330, 332. The communication buses 320, 322 may be the communication buses 218, 222, respectively.

In some examples, the processor 312 couples to the storage device 314, the input device 304 via the communication bus 330, the input device 306 via the communication bus 332, the hardware microphone indicator 308 via the communication bus 320, the hardware camera indicator 310 via the communication bus 322, the audio connector 316, and the video connector 318. The storage device 314 may store machine-readable instructions that, when executed by the processor 312, may cause the processor 312 to perform some or all of the actions attributed herein to the processor 312. The machine-readable instructions may be the machine-readable instructions 324, 326, 328.

In various examples, when executed by the processor 312, the machine-readable instructions 324, 326, 328 cause the processor 312 to control the hardware microphone indicator 308 and the hardware camera indicator 310. The machine-readable instruction 324 causes the processor 312 to execute a first or a second application. The machine-readable instruction 326 causes the processor 312 to, in response to execution of the first application, display a first colored hardware microphone indicator 308 and a second colored hardware camera indicator 310. For example, based on the processor 312 executing a conferencing application, the processor 312 switches the hardware microphone indicator 308 to display a color that indicates the state of the microphone in the conferencing application and switches the hardware camera indicator 310 to display a color that indicates the state of the camera in the conferencing application. The machine-readable instruction 328 causes the processor 312 to, in response to execution of the second application, display a third colored hardware microphone indicator 308 and a fourth colored hardware camera indicator 310. For example, based on the processor 312 executing a non-conferencing application, the processor 312 switches the hardware microphone indicator 308 to display a color that indicates the state of the microphone, where the color is a color other than the color utilized for the state of the microphone in the conferencing application. The processor 312 switches the hardware camera indicator 310 to display a color that indicates the state of the camera, where the color is a color other than the color utilized for the state of the camera in the conferencing application.

By providing hardware indicators 308, 310 for the camera and the microphone, the user experience is improved because, regardless of which application is in use and without looking in multiple locations, the user is able to quickly discern whether the camera is on or off, whether the microphone is muted or unmuted, and what type of application is in use. By including application-based sensors with the hardware indicators 308, 310, the user experience is improved because, the user is able to quickly disable or enable the camera or mute or unmute the microphone based on the application in use.

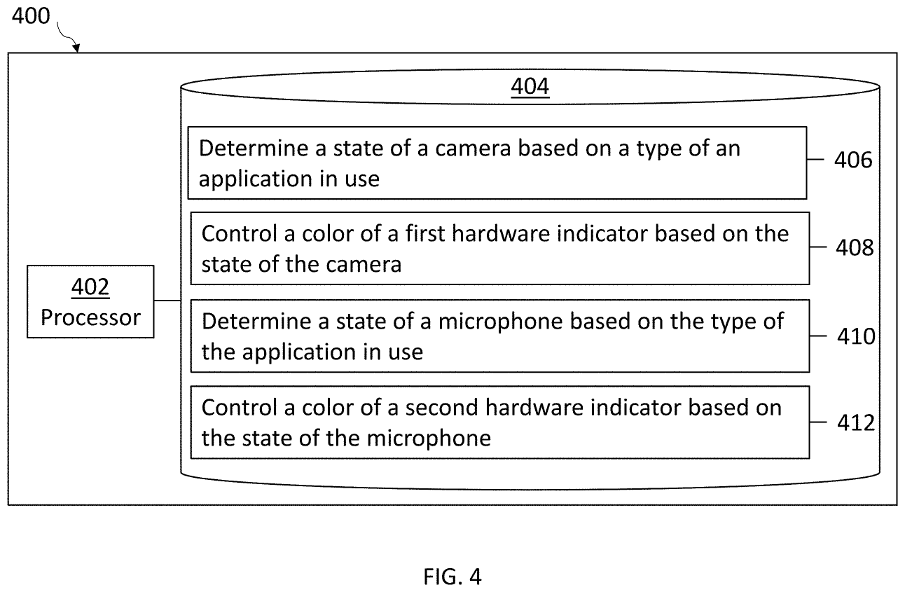

Referring now to FIG. 4, a schematic diagram of an electronic device 400 for controlling hardware indicators (not explicitly shown) for recording devices (not explicitly shown) is depicted, in accordance with various examples. The electronic device 400 may be the electronic device 300, 200, 100. The hardware indicators (not explicitly shown) may be the hardware indicators 112, 114; 206, 210; 308, 310. The recording devices (not explicitly shown) may be a camera, a microphone, or both a camera and a microphone. The recording devices may be the recording devices 108, 110; 204, 208; or devices coupled to the audio connector 316 and the video connector 318. The electronic device 400 comprises the processor 402 and the non-transitory machine-readable medium 404. The non-transitory machine-readable medium 404 may be the storage device 214, 314. The term “non-transitory” does not encompass transitory propagating signals.

In various examples, the electronic device 400 comprises the processor 402 coupled to the non-transitory machine-readable medium 404. The non-transitory machine-readable medium 404 may store machine-readable instructions. The machine-readable instructions may be the machine-readable instructions 406, 408, 410, 412. The machine-readable instructions 406, 408, 410, 412, when executed by the processor 402, may cause the processor 402 to perform some or all of the actions attributed herein to processor 402.

In various examples, when executed by the processor 402, the machine-readable instructions 406, 408, 410, 412 cause the processor 402 to control the colors of the hardware indicators for the recording devices. The machine-readable instruction 406 may cause the processor 402 to determine a state of a camera based on a type of an application in use. The machine-readable instruction 408 may cause the processor 402 to control a color of a first hardware indicator based on the state of the camera. The machine-readable instruction 410 may cause the processor 402 to determine a state of a microphone based on the type of the application in use. The machine-readable instruction 412 may cause the processor 402 to control a color of a second hardware indicator based on the state of the microphone.

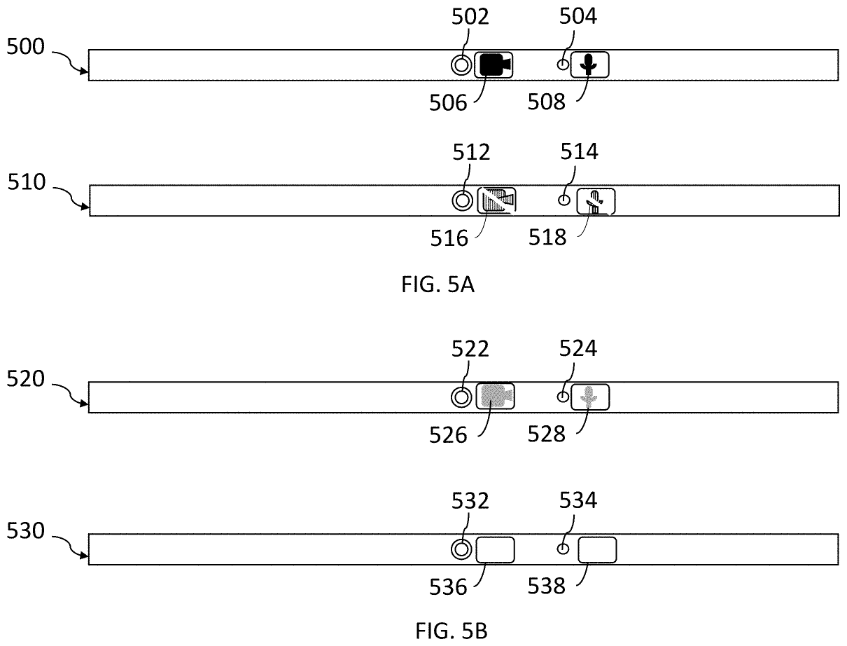

Referring now to FIGS. 5A and 5B, examples of states of application-based hardware indicators for recording devices of an electronic device are depicted, in accordance with various examples. The electronic device may by the electronic device 100, 200, 300, 400. FIGS. 5A and 5B include chassis 500, 510, 520, 530 comprising recording devices 502, 504; 512, 514; 522, 524; 532, 534, respectively, and hardware indicators 506, 508; 516, 518; 526, 528; 536, 538, respectively. The chassis 500, 510, 520, 530 may be the bezel 106, the display bezel 202, the chassis 302. The recording devices 502, 512, 522, 532 may be the camera 110, 208 or a camera coupled to the video connector 318. The recording devices 504, 514, 524, 534 may be the microphone 108, 204 or a microphone coupled to the audio connector 316. The hardware indicator 506 may be the hardware camera indicator 114, 210, 310. The hardware indicator 508 may be the hardware microphone indicator 112, 206, 308.

FIG. 5A is an example of the on and off states for the microphone 504, 514, respectively, and the camera 502, 512, respectively, in response to a first type of an application. The first type of the application may be a conferencing type or a secured type. The hardware camera indicator 506 and the hardware microphone indicator 508 are a first color in response to the on state of the camera 502 and the microphone 504, respectively. The hardware camera indicator 506 and the hardware microphone indicator 508 have a first image in response to the on state of the camera 502 and the microphone 504, respectively. For example, in response to the on state of the camera 502 and the microphone 504, respectively, the hardware camera indicator 506 has an image of a camera and the hardware microphone indicator 508 has an image of a microphone. The hardware camera indicator 516 and the hardware microphone indicator 518 have a second color in response to the off state of the camera 512 and the microphone 514, respectively. The hardware camera indicator 516 and the hardware microphone indicator 518 have a second image in response to the off state of the camera 512 and the microphone 514, respectively. For example, in response to the off state of the camera 512 and the microphone 514, respectively, the hardware camera indicator 516 has an image of a camera having a slash across the camera and the hardware microphone indicator 518 has an image of a microphone having a slash across the microphone.

FIG. 5B is an example of the on and off states for the microphone 524, 534, respectively, and the camera 522, 532, respectively, in response to a second type of an application. The second type of the application may be a non-conferencing type or a non-secured type. The hardware camera indicator 526 and the hardware microphone indicator 528 are a third color in response to the on state of the camera 522 and the microphone 524, respectively. The hardware camera indicator 526 and the hardware microphone indicator 508 have a third image in response to the on state of the camera 522 and the microphone 524, respectively. For example, in response to the on state of the camera 522 and the microphone 524, respectively, the hardware camera indicator 526 has an image of a camera and the hardware microphone indicator 528 has an image of a microphone. The hardware camera indicator 536 and the hardware microphone indicator 538 are a fourth color in response to the off state of the camera 532 and the microphone 534, respectively. The hardware camera indicator 536 and the hardware microphone indicator 538 have a fourth image in response to the off state of the camera 532 and the microphone 534, respectively. For example, in response to the off state of the camera 532 and the microphone 534, respectively, the hardware camera indicator 516 and the hardware microphone indicator 518 have blank images.

By providing hardware indicators 506, 508; 516, 518; 526, 528; 536, 538 for the camera 502, 512, 522, 532 and the microphone 504, 514, 524, 534, the user experience is improved because, regardless of which application is in use and without looking in multiple locations, the user is able to quickly discern whether the camera 502, 512, 522, 532 is on or off, whether the microphone 504, 514, 524, 534 is muted or unmuted, and what type of application is in use.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein may be shown in exaggerated scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

1. An electronic device, comprising:
a display device having a first hardware indicator and a second hardware indicator;
a camera, wherein the first hardware indicator includes a sensor to control activation of the camera, and the sensor is a touch-responsive device;
a microphone; and
a processor coupled to the microphone, the camera, and the first and the second hardware indicators, the processor to:
based on a type of an application in use, control the first hardware indicator in response to a state of the camera, wherein the application has access to the camera and the microphone;
based on the type of the application in use, control activation of the sensor; and
based on the type of the application in use, control the second hardware indicator in response to a state of the microphone.

2. The electronic device of claim 1, wherein the first and second hardware indicators comprise lights, and wherein the processor is to control the first and second hardware indicators by switching the lights on in response to on states of the camera and the microphone, respectively, and by switching the lights off in response to off states of the camera and the microphone, respectively.

3. The electronic device of claim 2, wherein the light of the first hardware indicator is a first color and wherein the light of the second hardware indicator is a second color.

4. The electronic device of claim 1, wherein the first and second hardware indicators comprise display panels, and wherein the processor is to:
cause the first hardware indicator to display a first image in response to the state of the camera; and
cause the second hardware indicator to display a second image in response to the state of the microphone.

5. The electronic device of claim 1, wherein the type of the application in use comprises a conferencing type, a non-conferencing type, a secured type, a non-secured type, or a combination thereof.

6. An electronic device, comprising:
a camera;
a microphone;
a display bezel having a first hardware indicator to indicate a state of the camera and a second hardware indicator to indicate a state of the microphone; and
a processor coupled to the camera, the microphone, and the first and second hardware indicators, the processor to:
execute a first application or a second application;
based on an execution of the first application, control the first hardware indicator to display a first color and the second hardware indicator to display a second color; and
based on an execution of the second application, control the first hardware indicator to display a third color and the second hardware indicator to display a fourth color.

7. The electronic device of claim 6, wherein the processor is to, responsive to the camera and the microphone having on states in the first and the second applications, control the first and the second hardware indicators to display the first and the second colors to have different colors than the third and fourth colors.

8. The electronic device of claim 6, wherein the processor is to:
based on the execution of the first application, control the first hardware indicator to display a first image and the second hardware indicator to display a second image; and
based on the execution of the second application, control the first hardware indicator to display a third image and the second hardware indicator to display a fourth image.

9. The electronic device of claim 8, wherein the processor is to, responsive to the camera and the microphone having off states in the first and the second applications, control the first and the second hardware indicators to display the first and the second images to have different images than the third and fourth images, respectively.

10. The electronic device of claim 6, wherein the processor is to:
based on the execution of the first application, disable sensors of the first and the second hardware indicators; and
based on the execution of the second application, enable the sensor of the first hardware indicator and disable the sensor of the second hardware indicator.

11. A non-transitory machine-readable medium storing machine-readable instructions which, when executed by a processor of an electronic device, cause the processor to:
determine a state of a camera based on a type of an application in use, wherein the type of the application in use includes a secured type or a non-secured type;
based on the state of the camera, control a color of a first hardware indicator housed within a chassis;
determine a state of a microphone based on the type of the application in use; and
based on the state of the microphone, control a color of a second hardware indicator housed within the chassis.

12. The non-transitory machine-readable medium of claim 11, wherein the color of the first hardware indicator is different than the color of the second hardware indicator.

13. The non-transitory machine-readable medium of claim 11, wherein, for a first type of an application in use, the colors of the first and the second hardware indicators are different than the colors of the first and the second hardware indicators for a second type of an application in use.

14. The non-transitory machine-readable medium of claim 11, wherein the machine-readable instructions, when executed by the processor, cause the processor to:
based on the state of the camera, control an image of the first hardware indicator; and
based on the state of the microphone, control an image of the second hardware indicator.

15. The non-transitory machine-readable medium of claim 11, wherein the machine-readable instructions, when executed by the processor, cause the processor to, based on the type of the application in use, disable a sensor of the first hardware indicator, the second hardware indicator, or a combination thereof.
